(19) United States
(12) Patent Application Publication
(10) Pub. No.: US 2012/0082872 A1
(43) Pub. Date: Apr. 5, 2012

(54) ADDITIVE FOR ELECTROLYTES

(75) Inventors: Rudiger Schmidt, Paderborn (DE); Daher Michael Badine, Mannheim (DE); Xiao Steimle, Immenstaad (DE); Helmut Moehwald, Annweiler (DE); Igor Kovalev, Vail, AZ (US); Yuriy V. Mikhaylik, Tucson, AZ (US)

(73) Assignees: BASF SE, Ludwigshafen (DE); Sion Power Corporation, Tucson, AZ (US)

(21) Appl. No.: 13/249,605

(22) Filed: Sep. 30, 2011

Related U.S. Application Data
(60) Provisional application No. 61/388,100, filed on Sep. 30, 2010.

(51) Int. Cl. H01M 10/056; H01M 4/58; H01M 4/40; H01M 4/48; H01M 10/02; H01M 4/38

(52) U.S. Cl. 429/50; 429/188; 429/199; 429/205; 429/339; 429/341; 429/340; 429/336; 429/337; 429/324; 429/326; 429/328; 429/334; 429/335; 429/317; 429/314; 429/315; 429/313; 429/309

(57) ABSTRACT

Spiro ammonium salts as an additive for electrolytes in electric current producing cells, in particular electric current producing cells comprising a Li-based anode, are provided. In some embodiments, the electric current producing cell comprises a cathode, a Li-based anode, and at least one electrolyte wherein the electrolyte contains at least one spiro ammonium salt.

### RELATED APPLICATIONS

The present application claims priority under 35 U.S.C. §119(e) to U.S. provisional patent application Ser. No. 61/388,100, filed Sep. 30, 2010, which is incorporated herein by reference in its entirety.

### FIELD OF INVENTION

The present application relates generally to electrochemical cells, and more specifically, to electrochemical cells, components and methods involving additives for electrolytes.

### BACKGROUND

There has been considerable interest in recent years in developing high energy density batteries with lithium containing anodes. Lithium metal is particularly attractive as the anode of electrochemical cells because of its extremely light weight and high energy density compared to other anodes, such as lithium intercalated carbon anodes, where the presence of non-electroactive materials increases weight and volume of the anode, and thereby reduces the energy density of the cells. Moreover, lithium metal anodes, or those comprising mainly lithium metal, provide an opportunity to construct cells which are lighter in weight, and which have a higher energy density than cells such as lithium-ion, nickel metal hydride or nickel-cadmium cells. These features are highly desirable for batteries for portable electronic devices such as cellular phones and laptop computers where a premium is paid for low weight. Unfortunately, the reactivity of lithium and the associated cycle life, dendrite formation, electrolyte compatibility, and fabrication and safety problems have hindered the commercialization of lithium cells. Despite the various approaches proposed for forming lithium anodes and forming interfacial and/or protective layers, improvements are needed.

### SUMMARY OF THE INVENTION

The present application relates generally to electrochemical cells, and more specifically, to electrochemical cells, components and methods involving additives for electrolytes. The subject matter of the present invention involves, in some cases, interrelated products, alternative solutions to a particular problem, and/or a plurality of different uses of one or more systems and/or articles.

Electric current producing cells are provided. In one set of embodiments, an electric current producing cell comprises a cathode, a Li-based anode, and at least one electrolyte interposed between said cathode and said anode, wherein the at least one electrolyte comprises at least one spiro ammonium salt.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic diagram showing an electrochemical cell according to one set of embodiments.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### DETAILED DESCRIPTION

Spiro ammonium salts as an additive for electrolytes in electric current producing cells, in particular electric current producing cells comprising a Li-based anode, are provided. In some embodiments, the electric current producing cell comprises a cathode, a Li-based anode, and at least one electrolyte wherein the electrolyte contains at least one spiro ammonium salt.

There is a high demand for long lasting rechargeable electric current producing cells having high energy density. Such electric current producing cells are used for portable devices as notebooks or digital cameras and will play a major role in the future for the storage of electric energy produced by renewable sources. Lithium has one of the highest negative standard potential of all chemical elements. Electric current producing cells with a Li-based anode therefore have very high cell voltages and very high theoretical capacities. For these reasons Li is very suited for use in electric current producing cells. One problem occurring with the use of Li in electric current producing cells is the high reactivity of Li, e.g. towards water and certain solvents. Due to its high reactivity the contact of Li with commonly used liquids electrolytes may lead to reactions between Li and the electrolyte whereby Li is consumed irreversibly. Hence, the long time stability of the electric current producing cell is affected adversely.

Depending on the material used for the cathode of the electric current producing cell further unwanted reactions of the Li may occur. For instance, one problem of Li/S-batteries is the good solubility of the polysulfides formed at the cathode in the electrolyte. The polysulfides may diffuse from the cathodic region into the anodic region. There, the polysulfides are reduced to solid precipitates (Li₂S₂ and/or Li₂S), resulting in a loss of active material at the cathode and therefore decreasing the capacity of the Li/S-battery. The rate of sulphur usage is normally about 60% of the deployed sulphur in the cathode.

The above-mentioned lithium sulphur (Li/S) battery is a rechargeable battery with promising characteristics. In Li/S-batteries, the anode active material may be Li-metal and the cathode active material may be sulphur. In the discharge modus Li⁰ dissociates into an electron and a Lit-ion which is dissolved in the electrolyte. This process is called lithium stripping. At the cathode the sulphur is initially reduced to polysulfides like Li₂S₈, Li₂S₆, Li₂S₄, and Li₂S₃. These polysulfides are soluble in the electrolyte. Upon further reduction Li₂S₂ and Li₂S are formed which precipitate.

In the charge modus of the Li/S-battery the Li⁻-ion is reduced to Li⁰ at the anode. The Li⁻-ion is removed from the electrolyte and precipitated on the anode, thereby. This is called lithium plating. Li₂S₂ and Li₂S are oxidized to polysulfides (like Li₂S₄, Li₂S₆, and Li₂S₈) and sulphur (S₈) at the cathode.

Li/S-batteries have a four times higher theoretical specific energy than Li-ion batteries, especially their gravimetric energy density (Wh/kg) is higher than that of Li-ion batteries. This is an important feature for their possible use as rechargeable energy source for automobiles. In addition, the sulphur used as main material in the cathode of the Li/S-batteries is much cheaper than the Li-ion intercalation compounds used in Li-ion batteries.

Despite the fact that there has been long and intense research in the field of Li-batteries like Li/S-batteries, there is still the need for further improvements of this kind of batteries to obtain Li-batteries which are capable of being charged/discharged a high number of cycles without losing too much of their capacity.

These issues may be addressed by articles described herein, such a Li-based anode for use in an electric current producing cell. In some embodiment, the Li-based anode comprises:

a cathode,

a Li-based anode, and

at least one electrolyte interposed between said cathode and said anode wherein the at least one electrolyte contains at least one spiro ammonium salt,

and by the use of spiro ammonium salts as additive in electrolytes for electric current producing cells, e.g., in electrolytes for Li-based electric current producing cells, and in particular, in electrolytes for electric current producing cells comprising a Li-based anode.

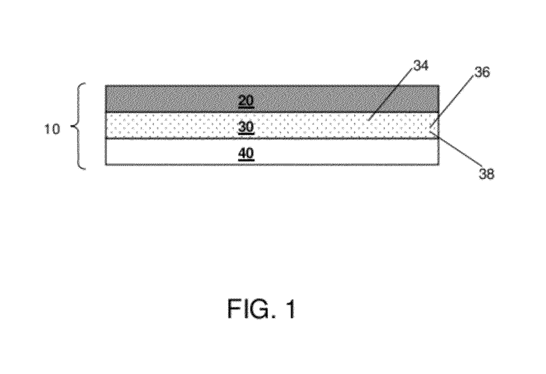

FIG. 1 shows an example of an electric current producing cell according to one set of embodiments. As shown illustratively in FIG. 1, electric current producing cell 10 includes a Li-based anode 20, an electrolyte 30, and a cathode 40. The electrolyte may be interposed between the anode and the cathode. In some cases, the electrolyte comprises at least one electrolyte salt 34. Optionally, the electrolyte may include a polymer 26 and/or an electrolyte solvent 38. In some embodiments, the electrolyte salt is a spiro ammonium salt as described herein. Although not shown in FIG. 1, in some embodiments a separator is positioned between anode 20 and cathode 40.

It should be appreciated that while much of the description provided herein involves components for use in lithium metal electrochemical cells, other alkali metal electrochemical cells as well as lithium-ion electrochemical cells may benefit from aspects of the invention. Furthermore, it should be understood that not all components shown in FIG. 1 need be present in the articles described herein. Additionally, articles such as electrochemical cells and precursors to electrochemical cells may include additional components that are not shown in FIG. 1. Moreover, articles may include other configurations and arrangements of components besides those shown in FIG. 1.

In one set of embodiments, the electric current producing cells described herein comprise an electrolyte containing at least one spiro ammonium salt. The spiro ammonium salts may have a positive influence on the cycle stability and performance of the cell.

Various configurations and variations of the articles and methods described herein are described in more detail below.

The term “electric current producing cell” as used herein is intended to include batteries, primary and secondary electrochemical cells and especially rechargeable batteries.

The term “Li-based anode” as used herein is intended to mean an anode comprising an anode active Li-containing compound as main constituent for the electro-chemical reactions occurring at the anode during the charge/discharge processes.

The term “anode active Li-containing compound” as used herein is intended to denote Li-containing compounds which release Li+-ions during discharge of the electric current producing cell, i.e. the Li contained in the anode active compound(s) is oxidized at the anode. During charge of the electric current producing cell (if the cell is a rechargeable cell) Li+-ions are reduced at the anode and Li is incorporated into the anode active Li-containing compound.

Anode active Li-containing compounds are known. The anode active Li-compound may be selected from the group consisting of lithium metal, lithium alloy and lithium intercalating compounds. All these materials are capable of reversibly intercalating lithium ions as Li0 or reversibly reacting with lithium ions to form a lithium (Li0) containing compound. For example, different carbon materials and graphite are capable of reversibly intercalating and de-intercalating lithium ions. These materials include crystalline carbon, amorphous carbon, or mixtures thereof. Examples for lithium alloys are lithium tin alloy, lithium aluminium alloy, lithium magnesium alloy and lithium silicium alloy. Lithium metal may be in the form of a lithium metal foil or a thin lithium film that has been deposited on a substrate. Lithium intercalating compounds include lithium intercalating carbons and lithium intercalating graphite. Lithium and/or Li-metal alloys can be contained as one film or as several films, optionally separated by a ceramic material (H). Suited ceramic materials (H) are described below.

The term “spiro ammonium” generally refers to a cation containing at least one quaternary positively charged N-atom which is the only common member of two rings. The common atom is designated as the spiro atom.

The at least one spiro ammonium salt may be selected from the group consisting of salts of the general formula (I)

[A¹]⁺ₙ[Y]ⁿ⁻ (I)

with n=1, 2, 3 or 4;

and of salts of the general formulae (IIa) to (IIc)

[A¹]⁺[A²]⁺[Y]ⁿ⁻ (IIa) with n=2,

[A¹]⁺[A²]⁺[A³]⁺[Y]ⁿ⁻ (IIb) with n=3, and

[A¹]⁺[A²]⁺[A³]⁺[A⁴]⁺[Y]ⁿ⁻ (IIc) with n=4,

wherein
[A¹]⁺ is a Spiro ammonium cation of the general formula

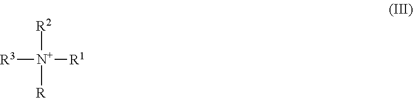

wherein the central N-atom, R and R¹; and the central N-atom, R² and R³ both form independently from each other a 3- to 9-membered saturated or unsaturated heterocycle; wherein the heterocycle may further contain and/or be substituted by from 1 to 5 heteroatoms and/or by from 1 to 5 substituents R⁴, R⁵, R⁶, R⁷ and R⁸ in addition to the central N-atom;
[A²]⁺, [A³]⁺ and [A⁴]⁺ independently from each other are selected from ammonium cations and spiro ammonium cations as defined for [A¹]⁺; and
[Y]ⁿ⁻ is a monovalent, bivalent, trivalent or tetravalent anion.

Possible heteroatoms suited for being contained in and/or substituting the 3- to 9-membered saturated or unsaturated heterocycles formed with the spiro N-atom are in principle all heteroatoms which are able to formally replace a —CH₂— group, a —CH═ group, a −C═ group or a ═C═ group. Oxygen, nitrogen, sulfur, phosphorus and silicon are the preferred heteroatoms. Preferred groups are, in particular, —O—, —S—, —SO—, —SO₂—, —NR′—, —N═, —PR′—, —PR′₂ and —SiR′₂—, where the radicals R′ are the remaining part of the carbon-comprising 3- to 9-membered saturated or unsaturated heterocycle. In some embodiments, the heteroatoms are selected from the group consisting of Si, N, O, S and P.

The substituents R⁴, R⁵, R⁶, R⁷ and R⁸ may be selected from the group consisting of F; Cl; Br, I; CN; OH, OR⁹; NH₂; NHR⁹; NR⁹R¹⁰, CO; ═NH; ═NR⁹, COOH; COOR⁹; CONH₂; CONHR⁹; CONR⁹R¹⁰; SO₃H; branched and unbranched C₁-C₂₀ alkyl and C₁-C₂₀ alkoxy; C₃-C₁₀ cycloalkyl; branched and unbranched C₂-C₂₀ alkenyl; C₃-C₁₀ cycloalkenyl; C₅-C₁₄ aryl, C₅-C₁₄ aryloxy; and C₅-C₁₄ heterocyclyl; wherein alkyl; alkoxy; cycloalkyl; alkenyl; cycloalkenyl; aryl; aryloxy; and heterocyclyl may be substituted by one or more substituents selected from the group consisting of F; Cl; Br, I; CN; OH, OR¹¹; NH₂; NHR¹¹; NR¹¹R¹², CO; ═NH; ═NR¹¹, COOH; COOR¹¹; CONH₂; CONHR¹¹; CONR¹¹R¹²; SO₃H; branched and unbranched C₁-C₆ alkyl and C₁-C₆ alkoxy; C₃-C₇ cycloalkyl; branched and unbranched C₂-C₆ alkenyl; C₃-C₇ cycloalkenyl; C₅-C₁₄ aryl; C₅-C₁₄ aryloxy; and C₅-C₁₄ heterocyclyl, with:

R⁹, R¹⁰, R¹¹ and R¹² are independently from each other selected from the group consisting of branched and unbranched C₁-C₆ alkyl and alkoxy; C₃-C₇ cycloalkyl; branched and unbranched C₂-C₆ alkenyl; C₃-C₇ cycloalkenyl; C₅-C₇ aryl and aryloxy; and C₅-C₇ heterocyclyl; which may be substituted by one or more substituents selected from the group consisting of F; Cl; Br, I; CN; OH, NH₂; CO; ═NH; COOH; CONH₂; SO₃H and branched and unbranched C₁-C₆ alkyl which may be substituted by one or more F; Cl; Br, I; CN; OH.

“Alkyl” means a linear or branched saturated aliphatic hydrocarbon group.

“Alkenyl” means a linear or branched unsaturated aliphatic hydrocarbon group with at least one double bond.

“Alkoxy” means the group O-alkyl, wherein “alkyl” is defined as above.

“Cycloalkyl” means a saturated hydrocarbon ring.

“Cycloalkenyl” means a partially unsaturated hydrocarbon ring having at least one double bond in the cycle.

“Aryl” means an aromatic hydrocarbon ring system with one aromatic hydrocarbon ring or two or three condensed aromatic hydro carbon rings.

“Aryloxy” denotes an O-aryl-group wherein “aryl” is defined as above.

“Heterocyclyl” means a saturated, unsaturated or aromatic hydrocarbon ring wherein at least one carbon atom of the cycle is replaced by at least one heteroatom. Possible heteroatoms suited for interrupting and/or substituting the heterocyclyl are in principle all heteroatoms which are able to formally replace a —CH₂— group, a —CH═ group, a —C≡ group or a ═C═ group. If the carbon-comprising heterocyclyl comprises heteroatoms, then oxygen, nitrogen, sulfur, phosphorus and silicon may be used. Non-limiting examples of groups are, in particular, —O—, —S—, —SO—, —SO₂—, —NR′—, —N═, —PR′—, —PR′₂ and —SiR′₂—, where the radicals R′ are the remaining part of the heterocyclyl radical.

C₁-C₂₀-alkyl groups may comprise linear and branched saturated alkyl groups having from 1 to 20 carbon atoms. The following radicals may be included in particular: C₁-C₆-alkyl, such as methyl, ethyl, n-propyl, iso-propyl, n-butyl, sec-butyl, 2- or 3-methylpentyl and longer-chain radicals such as non-branched heptyl, octyl, nonyl, decyl, undecyl, lauryl and the singly or multiply branched analogues thereof.

C₁-C₂₀-alkoxy groups may include, for example, methoxy, ethoxy, n-propoxy, i-propoxy, n-butoxy. t-butoxy, i-butoxy, pentoxy and longer-chain radicals derived from alcohols like hexanol, heptanol, octanol, nonanol, decanol, undecanol, lauryl alcohol, myristyl alcohol and cetyl alcohol and the singly or multiply branched analogues thereof

C₃-C₁₀-cycloalkyl groups may include, for example, cyclopropyl, cyclobutyl, cyclopentyl, cyclohexyl, cycloheptyl, cyclooctyl, cyclononyl and cyclodecyl.

C₅-C₁₄-aryl groups may be derived from, for example, benzene, naphthalene anthracen, phenanthrene and naphthacene.

C₁-C₂₀ alkenyl may be selected from, for example, ethenyl, propenyl, 1-butenyl, 2-butenyl, i-butenyl, 1-pentenyl, 2-pentenyl, 1-hexenyl, 2-hexenyl, 3-hexenyl, heptenyl 2-ethyl-hexenyl, octenyl, nonenyl, decenyl, undecenyl, dodecenyl and the singly or multiply branched analogues thereof.

C₃-C₁₀ cycloalkenyl include, for example, cyclopropenyl; cyclobutenyl, cyclopentenyl, cyclohexenyl, cycloheptenyl, cyclooctenyl, cyclononenyl and cyclodecenyl

C₅-C₁₄ aryloxy include, for example, phenoxy.

C₃-C₁₄ heterocyclyl groups may contain 1 to 4 heteroatoms selected from the group N, O and S. C₃-C₁₄ heterocyclyl groups may be derived from the following heterocyclic compounds: tetrahydrofurane, pyrrolidine, tetrahydrothiophene, oxazolidine, piperidine, tetrahydropyrane, piperazine, dioxane, morpholine and trioxane.

In some embodiments, [Y]ⁿ⁻ may be selected from
the group consisting of halides and halogen containing compounds of formulae: F, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group consisting of sulfates; sulfites and sulfonates of general formulae: SO₄²⁻, HSO₄⁻, SO₃²⁻, HSO₃⁻, R^{a}OSO₃⁻, R^{a}SO₃⁻
NO₃⁻
the group consisting of phosphates of general formulae: PO₄³, HPO₄²⁻, H₂PO₄⁻, R^{a}PO₄²⁻, HR^{a}PO₄⁻, R^{a}R^{b}PO₄⁻
the group consisting of phosphonates and phosphinates of general formulae: R^{a}HPO₃⁻, R^{a}R^{b}PO₂⁻, R^{a}R^{b}PO₃⁻
the group consisting of phosphites of general formulae: PO₃³⁻, HPO₃²⁻, H₂PO₃⁻, R^{a}PO₃²⁻, R^{a}HPO₃⁻, R^{a}R^{b}PO₃⁻
the group consisting of phosphonites and phosphinites of general formulae: R^{a}R^{b}PO₂⁻, R^{a}HPO₂⁻, R^{a}R^{b}PO⁻, R^{a}HPO⁻
the group consisting of carboxylic acids of general formulae: R^{a}COO⁻
the group consisting of borates of general formulae: BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group consisting of boronates of general formulae: R^{a}BO₂²⁻, R^{a}R^{b}BO⁻
the group consisting of silicates and esters of silicic acid of general formulae: SiO₄^{4-, HSiO}₄³⁻, H₂SiO₄²⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group consisting of salts of alkyl- and arylsilane of general formulae: R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group consisting of carboxylic acid imides; bis(sulfonyl)imides and sulfonyl-imides of general formulae:

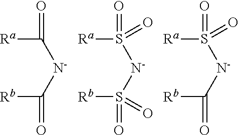

the group consisting of methide of general formulae:

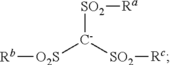

wherein R^{a}, R^{b}, R^{c} and R^{d} independently from each other are selected from hydrogen; C₁-C₃₀-alkyl, C₂-C₁₈-alkyl, C₆-C₁₄-aryl, C₅-C₁₂-cycloalkyl, optionally interrupted by one or more non-adjacent oxygen atoms and/or sulfur atoms and/or one or more substituted or unsubstituted iminogroups; or a five- to six-membered oxygen nitrogen and/or sulfur atoms comprising heterocycle; wherein two of R^{a}, R^{b}, R^{c} and R^{d} may together form a saturated, unsaturated or aromatic ring, optionally interrupted by one or more oxygen atoms and/or sulfur atoms and/or one or more unsubstituted or substituted iminogroups, wherein R^{a}, R^{b}, R^{c} and R^{d} additionally may be substituted by functional groups, aryl, alkyl, aryloxy, alkyloxy, halogen, hetero atoms and/or heterocycles.

In some embodiments, [Y]ⁿ⁻ is selected from the group consisting of halides; halogen containing compounds; carboxylic acids; NO₃⁻; SO₄²⁻, SO₃²⁻, R^{a}OSO₃⁻; R^{a}SO₃⁻; PO₄³⁻ and R^{a}R^{b}PO₄⁻.

Compounds suitable for the formation of the spiro ammonium cation [A]⁺ are known. Such compounds may contain at least one nitrogen and optionally oxygen, phosphorus, sulfur and/or Si. In some cases, they contain from 1 to 5 nitrogen atoms, e.g., from 1 to 3 nitrogen atoms, or 1 or 2 nitrogen atoms. If appropriate, further heteroatoms such as oxygen, sulfur or phosphorus atoms can also be included. The ammonium cation can firstly be produced by quaternization of the nitrogen atom of, for instance, an NH-group containing heterocycle in the synthesis of the ammonium spiro salt. Quaternization may be affected by alkylation of the nitrogen atom with an alkyl halide which is yet bound to the nitrogen atom, e.g., spiro-1,1′-bipyrrolidine-1-ylium may be prepared via alkylation of pyrrolidine with 1,4-dichlorobutane. Depending on the alkylation reagent used, salts having different anions may be obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein, which are incorporated herein by reference.

If a halogen is included, the halogen may be fluorine, chlorine, bromine or iodine.

In some embodiments, the spiro ammonium cation includes two rings connected by the spiro N-atom, which are independently selected from pyridinium ions; pyridazinium ions; pyrimidinium; pyrazolium ions; imidazolium ions; pyrazolinium ions; imidazolium ions; pyrazolinium ions; imidazolinium ions; thiazolium ions; triazolium ions; pyrolidinium ions; imidazolidinium ions; piperidinium ions; morpholinium ions; guanidinium ions and cholinium ions which may be substituted or unsubstituted.

In some cases, the spiro ammonium cation includes spiro-1,1′-bipyrrolidine-1-ylium as the cation of the spiro ammonium salt.

In some embodiments, the anion [Y]ⁿ⁻ is selected from among, for example:
the group of halides and halogen-comprising compounds of the formulae: F⁻, Cl⁻, Br⁻, I⁻, BF₄⁻, PF₆⁻, AICI₄⁻, AI₂CI₇⁻, AI₃CI₁₀⁻, AIBr₄⁻, FeCI₄⁻, BCI₄⁻, SbF₆⁻, AsF₆⁻, ZnCI₃⁻, SnCI₃⁻, CuCI₂⁻, CF₃SO₃⁻, (CF₃SO₃)₂N⁻, CF₃CO₂⁻, CCl₃CO₂⁻, CN⁻, SCN⁻, OCN⁻
NO₃⁻
the group of sulfates, sulfites and sulfonates of the general formulae: SO₄²⁻, HSO₄⁻, SO₃²⁻, HSO₃⁻, R^{a}OSO₃⁻, R^{a}SO₃⁻
the group of phosphates of the general formulae PO₄³⁻, HPO₄²⁻, H₂PO₄^{—}, R^{a}PO₄²⁻, HR^{a}PO₄⁻, R^{a}R^{b}PO₄⁻
the group of phosphonates and phosphinates of the general formulae: R^{a}HPO₃⁻, R^{a}R^{b}PO₂⁻, R^{a}R^{b} PO₃⁻
the group of phosphites of the general formulae: PO₃³⁻, HPO₃²⁻, H₂PO₃⁻, R^{a}PO₃²⁻, R^{a}HPO₃⁻, R^{a}R^{b}PO₃⁻,
the group of phosphonites and phosphinites of the general formulae: R^{a}R^{b}PO₂⁻, R^{a}HPO₂⁻, R^{a}R^{b}PO⁻, R^{a}HPO⁻
the group of carboxylic acids of the general formula: R^{a}COO⁻
the group of borates of the general formulae: BO₃³₃₋, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae: R^{a}BO₂²⁻, R^{a}R^{b}BO⁻
the group of carbonates and carboxylic esters of the general formulae: HCO₃⁻, CO₃²⁻, R^{a}CO₃⁻
the group of silicates and silicic esters of the general formulae: SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae: R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae:

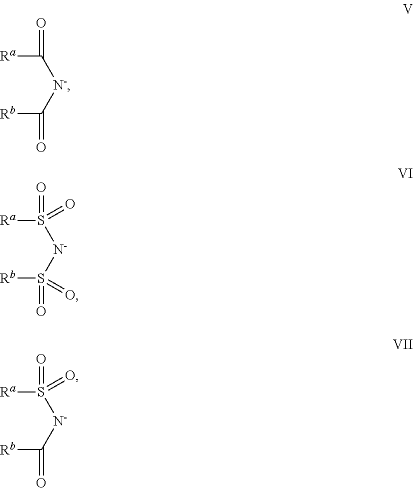

the group of the general formula:

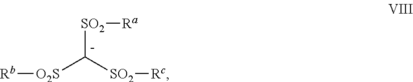

the group of alkoxides and aryloxides of the general formula: R^{a}O⁻;
the group of sulfides, hydrogensulfides, polysulfides, hydrogenpolysulfides and thiolates of the general formulae: S²⁻, HS⁻, [Sᵥ]²⁻, [HSᵥ]⁻, [R^{a}S]⁻, where v is a positive integer from 2 to 10;

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

In one set of embodiments, [Y] is NO₃⁻. In some embodiments, NO₃⁻ is able to form a film on the anode active Li-ion containing compound or the protective layer optionally present in the Li-based anode.

In some embodiments, the electrolyte contains at least 0.01 wt.-%, at least 0.05 wt.-%, at least 0.1 wt.-%, at least 0.5 wt.-%, at least 1 wt.-%, at least 2 wt.-%, at least 3 wt.-%, at least 4 wt.-%, or at least 5 wt.-% of the at least one spiro ammonium salt, based on the total weight of the electrolyte. In certain embodiments, the electrolyte may contain at maximum 20 wt.-%, at maximum 15 wt.-%, at maximum 10 wt.-%, at maximum 6 wt.-%, at maximum 5 wt.-%, at maximum 4 wt.-%, at maximum 3 wt.-%, or at maximum 2 wt.-% of at least one spiro-ammonium salt, based on the total weight of the electrolyte. Combinations of the above-noted ranges are also possible (e.g., an electrolyte containing at least 0.05 wt.-% and at maximum 3 wt.-% of the at least one spiro ammonium salt, based on the total weight of the electrolyte).

In certain embodiments, the Li-based anode 20 may further comprise at least one protective layer which is located between the at least one anode active Li-containing compound and the one or more electrolyte used in the electric current producing cell. The protective layer may be a single ion conducting layer, i.e. a polymeric ceramic, or metallic layer that allows Li⁺ ions to pass through but which prevents the passage of other components that may otherwise damage the electrode. The material for the protective layer may be selected from Lithium is known as such. In some embodiments, suitable ceramic materials (H) may be selected from silica, alumina, or lithium containing glassy materials such as lithium phosphates, lithium aluminates, lithium silicates, lithium phosphorous oxynitrides, lithium tantalum oxide, lithium aluminosulfides, lithium titanium oxides, lithium silcosulfides, lithium germanosulfides, lithium aluminosulfides, lithium borosulfides, and lithium phosphosulfides, and combinations of two or more of the preceding. Other materials may also be used. In some embodiments, a multi-layered protective structure may be used, such as those described in U.S. Pat. No. 7,771,870 filed Apr. 6, 2006 to Affinito et al., and U.S. Pat. No. 7,247,408 filed May 23, 2001 to Skotheim et al., each of which is incorporated herein by reference for all purposes.

In some embodiments, the electric current producing cell comprises at least one electrolyte interposed between the cathode and the anode. The electrolyte(s) function as a medium for the storage and transport of ions. The electrolyte(s) may be solid phase or liquid phase. Any suitable ionic conductive material can be used as long as the ionic conductive material is electrochemically stable. In certain embodiments, the ionic conductive material has an ion conductivity of at least 1×10⁻⁶ S/cm, at least 5×10⁻⁶ S/cm, at least 1×10⁻⁵ S/cm, at least 5×10⁻⁵ S/cm, at least 1×10⁻⁴ S/cm, or least 5×10⁻⁴ S/cm. The Li ion conductivity may be in the range of, for example, between 1×10⁻⁶ S/cm to 1×10⁻³ S/cm, between 1×10⁻⁵ S/cm to 1×10⁻² S/cm, or between 1×10⁻⁴ S/cm to 1×10⁻² S/cm. Other values and ranges of Li ion conductivity are also possible.

The one or more electrolytes may comprise one or more materials selected from the group consisting of liquid electrolytes, gel polymer electrolytes, and solid polymer electrolyte. In some embodiments, the one or more electrolytes comprise
one or more ionic electrolyte salts 34; and
one or more polymers 36 selected from the group consisting of polyethers, polyethylene oxides, polypropylene oxides, polyimides, polyphophazenes, polyacrylonitriles, polysiloxanes; derivatives thereof, blends thereof, and copolymers thereof; and/or
one or more electrolyte solvents 38 selected from the group consisting of N-methyl acetamide, acetonitrile, carbonates, sulfolanes, sulfones, N-substituted pyrrolidones, acyclic ethers, cyclic ethers, xylene, polyether including glymes, and siloxanes.

The one or more ionic electrolyte salts be selected from the group consisting of lithium salts including lithium cations, salts including organic cations, or a mixture thereof.

Examples of lithium salts include LiPF₆, LiBF₄, LiB(C₆H₅)₄, LiSbF₆, LiAsF₆, LiClO₄, LiCF₃SO₃, LiCF₃CH₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (wherein x and y are natural numbers), LiSCN, LiCl, LiBr, LiI, LiNO₃ and mixtures thereof.

Examples for organic cation included salts are cationic heterocyclic compounds like pyridinium, pyridazinium, pyrimidinium, pyrazinium, imidazolium, pyrazolium, thiazolium, oxazolium, pyrolidinium, and triazolium, or derivatives thereof. Examples for imidazolium compounds are 1-ethyl-3-methyl-imidazolium (EMI), 1,2-dimethyl-3-propylimidazolium (DMPI), and 1-butyl-3-methylimidazolium (BMI). The anion of the organic cation including salts may be bis(perfluoroethylsulfonyl)imide (N(C₂F₅SO₂)₂⁻, bis(trifluoromethylsulfonyl)imide(NCF₃SO₂)₂⁻), tris(trifluoromethylsulfonylmethide(C(CF₃SO₂)₂⁻, trifluoromethansulfonimide, trifluorome-thylsulfonimide, trifluoromethylsulfonat, AsF₆⁻, ClO₄⁻, PF₆⁻, BF₄⁻, B(C₆H₅)₄⁻. sbF₆⁻, CF₃SO₃⁻, CF₃CH₃⁻, C₄F₉SO₃⁻, AlO₄⁻, AlCl₄—, N(CₓF₂ₓ₊₁SO₂) (CyF_{2y+1}SO₂) wherein x and y are natural numbers), SCN⁻, Cl⁻, Br⁻ and I⁻.

Furthermore, in some embodiments the electrolyte may contain ionic N—O electrolyte additives as described in WO 2005/069409 on page 10. In one particular set of embodiments, the electrolyte comprises LiNO₃, guanidine nitrate and/or pyridinium nitrate.

In one set of embodiments, the electrolyte salts are selected from the group consisting of LiCF₃SO₃, Li(CF₃SO₂)₂N, LiC₄F₉SO₃, LiNO₃ and LiI.

In some embodiments, the one or more electrolyte solvents are non-aqueous.

In one set of embodiments, the one or more electrolyte solvents comprises a glyme. Glymes comprise diethylene glycol dimethylether (diglyme), triethylenglycol dimethyl ether (triglyme), tetraethylene glycol dimethylether (tetraglyme) and higher glymes. Polyethers comprise glymes, ethylene glycol divinyl ether, diethylene glycol divinyl ether, triethylene glycol divinyl ether, dipropylene glycol dimethyl ether, and butylenes glycol ethers.

In one set of embodiments, the one or more electrolyte solvents comprises an acrylic ether. Acrylic ethers include dimethylether, dipropyl ether, dibutylether, dimethoxy methane, trimethoxymethane, dimethoxyethane, diethoxymethane, 1,2-dimethoxy propane, and 1,3-dimethoxy propane.

Cyclic ethers comprise tetrahydrofuran, tetrahydropyran, 2-methyltetrahydrofuran, 1,4-dioxane, trioxane, and dioxolanes.

The one or more electrolyte solvents may be selected from the group consisting of dioxolanes and glymes. In some cases, the one or more solvent is selected from dimethylether, dimethoxyethane, dioxolane and mixtures thereof.

In some embodiments, the one or more electrolyte comprise:
one or more ionic electrolyte salts 34; and
one or more electrolyte solvents 38 selected from the group consisting of N-methyl acetamide, acetonitrile, carbonates, sulfolanes, sulfones, N-substituted pyrrolidones, acyclic ethers, cyclic ethers, xylene, polyether including glymes, and siloxanes.

The cathode contains at least one cathode active material. The cathode active material may be selected from the group consisting of sulphur (e.g. elemental sulphur), MnO₂, SOCl₂, SO₂Cl₂, SO₂, (CF)ₓ, I₂, Ag₂CrO4, Ag₂V₄O₁₁, CuO, CuS, PbCuS, FeS, FeS₂, BiPb₂O₅, B₂O₃, V₂O₅, CoO₂, CuCl₂ and Li intercalating C.

In one set of embodiments, the cathode active material is sulphur. Since sulphur is non-conductive it is usually used together with at least one conductive agent. The conductive agent may be selected from the group consisting of carbon black, graphite, carbon fibres, graphene, expanded graphite, carbon nanotubes, activated carbon, carbon prepared by heat treating cork or pitch, a metal powder, metal flakes, a metal compound or a mixture thereof. The carbon black may include ketjen black, denka black, acetylene black, thermal black and channel black. The metal powder and the metal flakes may be selected from Sc, Ti, V, Cr, Mn, Fe, Co, Ni, Cu, Zn, Al, etc. Furthermore, the conductive agents may be electrically conductive polymers and electrically conductive metal chalcogenides.

The electric current producing cell may further comprise a separator between the anodic and the cathodic region of the cell. A separator may be used, for example, if the catholyte is a liquid phase. Typically, the separator is a porous non-conductive or insulative material which separates or insulates the anodic and the cathodic region from each other and which permits the transport of ions through the separator between the anodic and the cathodic region of the cell. The separator may be selected from porous glass, porous plastic, porous ceramic and porous polymer.

If the electric current producing cell comprises a solid or a gel polymer electrolyte, this solid/gel polymer electrolyte may act as separator separating mechanically the anodic region from the cathodic region and may serve as well as a medium to transport metal ions. The solid electrolyte separator may comprise a non-aqueous organic solvent. In this case the electrolyte may further comprise a suitable gelling agent to decrease the fluidity of the organic solvent.

The following examples are intended to illustrate certain embodiments of the present invention, but are not to be construed as limiting and do not exemplify the full scope of the invention.

### COMPARATIVE EXAMPLE 1

### Capacity of an Electrochemical Cell Comprising a Li-Based Anode Without Addition of a Spiro Ammomium Salt

The cathode used in the electrochemical cell included 55 wt.-% sulfur, 20 wt.-% XE-2 carbon, 20 wt.-% Vulcan carbon, and 5 wt-% polyvinylalcohol binder with sulfur active material loading of 1.85 mg/cm². The total cathode active area in the cell was about 90 cm². The separator was Tonen, a micorporous polyethylene; thickness: 9 μm; 270 Gurley seconds. The anode was 50 μm thick Li-foil purchased from Chemetall. The electrolyte used was a solution of 4 g lithium nitrate, 8 g lithium bis-(trifluoromethylsulfon)imide, 1 g guanidinium nitrate, and 0.4 g pyridinium nitrate in 43.8 g 1,2-dimethoxy ethane and 43.8 g 1,3-dioxolane.

All cycling experiments were performed under a pressure of 10 kg/cm². The discharge-charge cycling of the cells was performed at 11 mA with discharge cut at a voltage of 1.7 V and charge cut off 2.5 V. The cell capacity was about 110 m Ah. The cycling was carried out at room temperature. The results are shown in table 1.

### EXAMPLE 1

### Capacity of an Electrochemical Cell Comprising a Li-Based Anode with Addition of a Spiro Ammomium Salt

An electrochemical cell as described in example 1 was used with the difference that 5-azoniaspiro[4.5]decane (TFSI) was added to the electrolyte yielding a concentration of 5 wt.-% of the TFSI in the electrolyte.

The cycling experiments were performed in analogy to Comparative Example 1. The results are shown in Table 1.

TABLE 1

| | 5^{th} cycle | 25^{th} cycle | 60^{th} cycle |
|---|---|---|---|
| | (mAh/g | (mAh/g | (mAh/g |
| | sulfur) | sulfur) | sulfur) |
| Comparative Example 1 | 1000 | 900 | 800 |
| Example 1 (5 wt.-% additive | 1010 | 1000 | 980 |
| in the electrolyte) | | | |

This example shows that the electrochemical cell described in Example 1 including a spiro ammonium salt had a higher capacity and could maintain longer cycling compared to the electrochemical cell described in Comparative Example 1.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one”.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electric current producing cell comprising:
a cathode;
a Li-based anode; and
at least one electrolyte interposed between said cathode and said anode,
wherein the at least one electrolyte comprises at least one spiro ammonium salt.

2. The electric current producing cell according to claim 1 wherein the at least one spiro ammonium salt is selected from the group consisting of salts of the general formula (I)
[A¹]⁺ₙ[Y]ⁿ⁻ (I)
with n=1, 2, 3 or 4;
and of salts of the general formulae (IIa) to (IIc)
[A¹]⁺[A²]⁺[Y]ⁿ⁻ (IIa) with n=2,
[A¹]⁺[A²]⁺[A³]⁺[Y]ⁿ⁻ (IIb) with n=3, and
[A¹]⁺[A²]⁺[A³]⁺[A⁴]⁺[Y]ⁿ⁻ (IIc) with n=4,
wherein
[A¹]⁺ is a spiro ammonium cation of the general formula 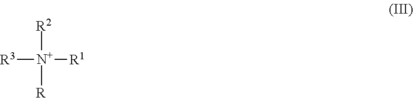
wherein the central N-atom, R and R¹; and the central N-atom, R² and R³ both form independently from each other a 3- to 9-membered saturated or unsaturated heterocycle;
wherein the heterocycle may further contain and/or be substituted by from 1 to 5 heteroatoms and/or by from 1 to 5 substituents R⁴, R⁵, R⁶, R⁷ and R⁸ in addition to the central N-atom;
[A²]⁺, [A³]⁺ and [A⁴]⁺ independently from each other are selected from ammonium cations and spiro ammonium cations as defined for [A¹]⁺; and
[Y]“ⁿ⁻is a monovalent, bivalent, trivalent or tetravalent anion.

3. The electric current producing cell according to claim 2 wherein the heteroatoms are selected from the group consisting of Si, N, O, S and P.

4. The electric current producing cell according to claim 2 wherein the substituents R⁴, R⁵, R⁶, R⁷ and R⁸ are selected from the group consisting of F; Cl; Br, I; CN; OH, OR⁹; NH₂; NHR⁹; NR⁹R¹⁰, CO; ═NH; ═NR⁹, COOH; COOR⁹; CONH₂; CONHR⁹; CONR⁹R¹⁰; SO₃H; branched and unbranched C₁-C₂₀ alkyl and C₁-C₂₀ alkoxy; C₃-C₁₀ cycloalkyl; branched and unbranched C₂-C₂₀ alkenyl; C₃-C₁₀ cycloalkenyl; C₅-C₁₄ aryl, C₅-C₁₄ aryloxy; and C₅-C₁₄ heterocyclyl; wherein alkyl; alkoxy; cycloalkyl; alkenyl; cycloalkenyl; aryl; aryloxy; and heterocyclyl may be substituted by one or more substituents selected from the group consisting of F; Cl; Br, I; CN; OH, OR¹¹; NH₂; NHR¹¹; NR¹¹R¹², CO; ═NH; ═NR¹¹, COOH; COOR¹¹; CONH₂; CONHR¹¹; CONR¹¹R¹²; SO₃H; branched and unbranched C₁-C₆ alkyl and C₁-C₆ alkoxy; C₃-C₇ cycloalkyl; branched and unbranched C₂-C₆ alkenyl; C₃-C₇ cycloalkenyl; C₅-C₁₄ aryl; C₅-C₁₄ aryloxy; and C₅-C₁₄ heterocyclyl, with
R⁹, R¹⁰, R¹¹and R¹² are independently from each other selected from the group consisting of branched and unbranched C₁-C₆ alkyl and alkoxy; C₃-C₇ cycloalkyl; branched and unbranched C₂-C₆ alkenyl; C₃-C₇ cycloalkenyl; C₅-C₇ aryl and aryloxy; and C₅-C₇ heterocyclyl; which may be substituted by one or more substituents selected from the group consisting of F; Cl; Br, I; CN; OH, NH₂; CO; ═NH; COOH; CONH₂; SO₃H and branched and unbranched C₁-C₆ alkyl which may be substituted by one or more F; Cl; Br, I; CN; OH.

5. The electric current producing cell according to claim 1 wherein the cation of the Spiro ammonium salt is spiro-1,1′-bipyrrolidine-1-ylium.

6. The electric current producing cell according to claim 2 wherein [Y]ⁿ⁻ is selected from
the group of halides and halogen-comprising compounds of the formulae: F⁻, Cl⁻, Br⁻, I⁻, BF₄⁻, PF₆⁻, AICI₄⁻, AI₂CI₇⁻, AI₃CI₁₀⁻, AIBr₄⁻, FeCI₄⁻, BCI₄⁻, SbF₆⁻, AsF₆⁻, ZnCI₃⁻, SnCI₃⁻, CuCI₂⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae: SO₄²⁻, HSO₄⁻, SO₃²⁻, HSO₃⁻, R^{a}OSO₃⁻, R^{a}SO₃⁻
NO₃⁻
the group consisting of phosphates of general formulae: PO₄³⁻, HPO₄²⁻, H₂PO₄⁻, R^{a}PO₄²⁻, HR^{a}PO₄⁻, R^{a}R^{b}PO₄⁻
the group consisting of phosphonates and phosphinates of general formulae: R^{a}HPO₃⁻, R^{a}R^{b}PO₂⁻, R^{a}R^{b}PO₃⁻
the group consisting of phosphites of general formulae: PO₃³⁻, HPO₃²⁻, H₂PO₃⁻, R^{a}PO₃²⁻, R^{a}HPO₃⁻, R^{a}R^{b}PO₃⁻
the group consisting of phosphonites and phosphinites of general formulae: R^{a}R^{b}PO₂⁻, R^{a}HPO₂⁻, R^{a}R^{b}PO⁻, R^{a}HPO⁻
the group consisting of carboxylic acids of the general formulae: R^{a}COO⁻
the group of carbonates and carboxylic esters of the general formulae: HCO₃⁻, CO₃²⁻, R^{a}CO₃⁻
the group of borates of the general formulae: BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae: R^{a}BO₂²⁻, R^{a}R^{b}BO⁻
the group of silicates and esters of silicic acid of the general formulae: SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group consisting of salts of alkylsilane and arylsilane of the general formulae: R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group consisting of carboximides; bis(sulfonyl)imides and sulfonylimides of the general formulae: 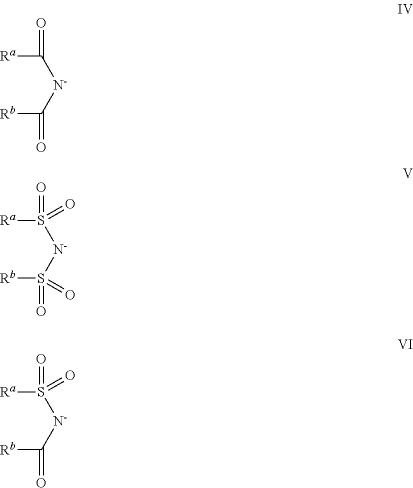
the group consisting of methide of the general formulae: 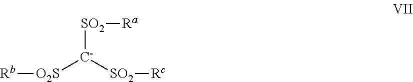
the group of alkoxides and aryloxides of the general formula: R^{a}O;
wherein R^{a}, R^{b}, R^{c} and R^{d} independently from each other are selected from hydrogen; C₁-C₃₀-alkyl; C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, and wherein two of R^{a}, R^{b}, R^{c} and R^{d} may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

7. The electric current producing cell according to claim 2 wherein [Y]ⁿ⁻ is selected from the group consisting of halides; halogen containing compounds; carboxylic acids; NO₃⁻; SO₄²⁻; SO₃²⁻, R^{a}OSO₃⁻; R^{a}SO₃⁻; PO₄²⁻ and R^{a}R^{b}PO₄.

8. The electric current producing cell according to claim 1 wherein the electrolyte comprises one or more electrolyte solvents selected from the group consisting of N-methyl acetamide, acetonitrile, carbonates, sulfolanes, sulfones, N-substituted pyrrolidones, acyclic ethers, cyclic ethers, xylene, polyether including glymes and siloxane.

9. The electric current producing cell according to claim 1 wherein the electrolyte comprises one or more lithium salts.

10. The electric current producing cell according to claim 9 wherein the one or more lithium salts are selected from the group consisting of LiPF₆, LiBF₄, LiB(C₆H₅)₄, LiSbF₆, LiAsF₆, LiClO₄, LiCF₃SO₃, LiCF₃CH₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (wherein x and y are natural numbers), LiSCN, LiCl, LiBr, LiI, LiNO₃ and mixtures thereof.

11. The electric current producing cell according to claim 1 wherein the electrolyte comprises one or more polymers selected from the group consisting of polyethers, polyethylene oxides, polypropylene oxides, polyimides, polyphophazenes, polyacrylonitriles, polysiloxanes; derivatives thereof, blends thereof, and copolymers thereof.

12. The electric current producing cell according to claim 1 wherein the Li-based anode comprises at least one anode active Li-containing compound selected from the group consisting of Li-metal, Li-alloys and Li-intercalating materials.

13. The electric current producing cell according to claim 1 wherein the cathode comprises at least one cathode active material selected from the group consisting of sulphur, MnO₂, SOCl₂, SO₂Cl₂, SO₂, (CF)ₓ, I₂, Ag₂CrO₄, Ag₂V₄O₁₁, CuO, CuS, PbCuS, FeS, FeS₂, BiPb₂O₅, B₂O₃, V₂O₅, CoO₂, CuCl₂ and Li intercalating C.

14. The electric current producing cell according to claim 1 wherein the cell further comprises a separator between the anode and the cathode.

15. A method comprising using the ammonium spiro salt as defined in claim 2 as an additive in the electrolyte for the electric current producing cell.
